(19) United States
(12) Patent Application Publication
(10) Pub. No.: US 2012/0179915 A1
(43) Pub. Date: Jul. 12, 2012

(54) SYSTEM AND METHOD FOR FULL DISK ENCRYPTION AUTHENTICATION

(75) Inventors: Deric S. Horn, Los Gatos, CA (US); Soren Carlson Spies, San Jose, CA (US); Bradley David Strand, Los Gatos, CA (US); Russell Dean Reece, Foster City, CA (US); Jonathan David Callas, San Jose, CA (US)

(73) Assignee: Apple Inc., Cupertino, CA (US)

(21) Appl. No.: 12/986,895

(22) Filed: Jan. 7, 2011

(51) Int. Cl. H04L 9/32; G06F 21/00

(52) U.S. Cl. 713/189; 726/19; 726/18

(57) ABSTRACT

Disclosed herein are systems, methods, and non-transitory computer-readable storage media for authenticating a user logging in to an operating system stored on an encrypted drive. A system configured to practice the method presents a login prompt and receives credentials from a user. The system accesses the operating system on the encrypted drive based on the credentials and starts the operating system. Then the system authenticates the user on the operating system based on the credentials, such as via login forwarding. The system can set up a unified login by receiving a request to encrypt a storage device, and based on received user credentials, generating user data associated with logging in to an operating system on the computing device and user data for encrypting the storage device. The system stores the user data in a manner to enable a unified login boot prompt.

### BACKGROUND

1. Technical Field

The present disclosure relates to authentication on a computing device and more specifically to a unified approach to authentication for an encrypted storage device and an operating system stored thereon.

2. Introduction

When a user enables full-disk encryption on a computing device, the user must pass two layers of authentication to use the computing device. First, the user must authenticate at the full-disk encryption level to gain access to the data stored on the computing device. Second, after the disk is decrypted or otherwise made readable, the user must authenticate at the operating system level to gain access to the operating system as well as settings, data, and applications stored thereon. This two layer authentication slows down the boot and login processing of a computing device while waiting for user input. Further, entering two sets of passwords can become tedious for users and if the user forgets the username or password of either of the layers of authentication, then the computing device is rendered unusable.

The additional security associated with full disk encryption carries with it a higher price in terms of effort, memory, and time, causing some users to avoid a simple data security measure.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for authenticating a user logging in to an operating system stored on an encrypted drive. A system configured to practice the method presents a login prompt to a user and receives credentials from the user via the login prompt. The credentials can include a username, a password, biometric authentication data, a personal identification number, a user login picture, a short name, a full name, and/or a title. The credentials can be associated with a volume key, a username, and a password, and the credentials for the encrypted drive and the operating system can be synchronized. The system accesses the operating system on the encrypted drive using the credentials and starts the operating system. Then the system authenticates the user on the operating system using the credentials. The system can store credentials, such as a username and password, in memory while the operating system starts, use the credentials for authentication after the operating system has started, and remove the credentials from the memory once the login is complete. As an added security measure, the system can deny access and disable the login prompt temporarily if the user enters invalid credentials. In order to provide a more pleasing and unified user experience, the login prompt can simulate a full login prompt of the operating system, even though the login prompt occurs before access to the operating system is available.

To that effect, the login prompt can include graphical elements in a same style as the operating system, simulating or emulating operating system specific widgets, color schemes, and so forth. The login prompt can display a user login picture, a short name, a full name, a biometric authentication widget, a password hint, a list of authorized users, computer name, operating system version, boot options, support options, and/or other login options. The first part of the received credentials and the second part of the received credentials can share at least some data.

Also disclosed herein are systems, methods, and non-transitory computer-readable storage media for generating credentials for a computing device. A system configured to practice the method receives a request from a user to encrypt a storage device of the computing device and receives user credentials associated with the request. Then, based on the user credentials, the system generates first user authentication data associated with logging in to an operating system on the computing device and second user authentication data associated with encryption of the storage device. The system stores both pieces of user data and enables a unified login boot prompt which, when presented with the user credentials, decrypts the storage device and logs in to the operating system based on the user credentials.

Also disclosed herein are systems, methods, and non-transitory computer-readable storage media for synchronizing an operating system login with a decryption authentication prompt. A system configured to practice the method includes a processor and an encrypted storage device storing an operating system and user data. Then the system includes a first module configured to control the processor to authenticate first user credentials associated with the operating system and second user credentials associated with decrypting the encrypted storage device, and a second module configured to control the processor to update a unified boot-time login prompt based on the first user credentials and the second user credentials, wherein the credentials provided at the unified boot-time login prompt are used for decrypting the encrypted storage device and logging in a user to an operating system based on a single set of user credentials.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example boot-time login prompt;

FIG. 3A illustrates an example flow of login credentials;

FIG. 3B illustrates an example of multiple user logins for an encrypted device;

FIG. 4 illustrates a first exemplary method embodiment for a single-login boot; and

FIG. 5 illustrates a second exemplary method embodiment for authenticating a user logging in to an operating system stored on an encrypted drive.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

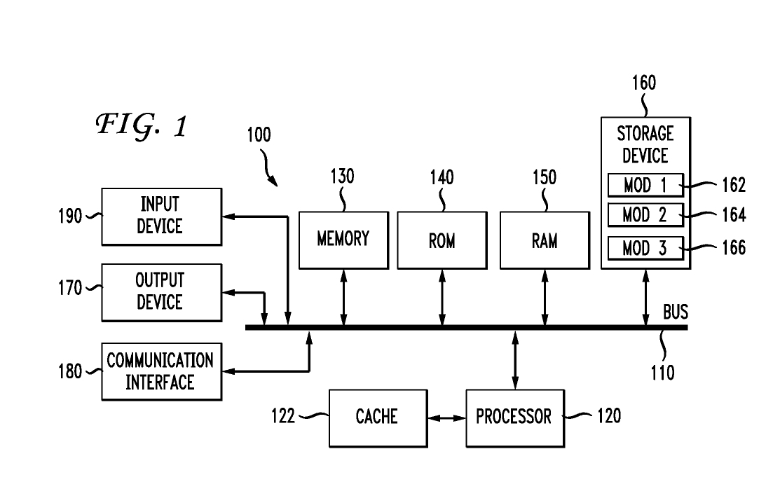

The present disclosure addresses the need in the art for a unified login for a computing device that authenticates a decryption process of an encrypted storage device and authenticates for use of an operating system stored on the encrypted storage device. A brief introductory description of a basic general purpose system or computing device is provided in FIG. 1 which can be employed to practice the concepts disclosed herein. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output system (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

Having disclosed some basic computing device concepts, the disclosure now returns to a discussion of full disk encryption authentication. As stated above, existing implementations of full disk encryption prompt a user twice when logging into a computer: once for the password to decrypt the drive (and then boot the operating system, etc) and again for an operating system user account password. The approach set forth herein merges these two steps by synchronizing the authentication data for the user account with the authentication data for the full disk encryption. From the user's perspective, only one dialog box is presented, but under the hood the authentication data is first used to decrypt the drive and then to log into the operating system loaded from the decrypted drive.

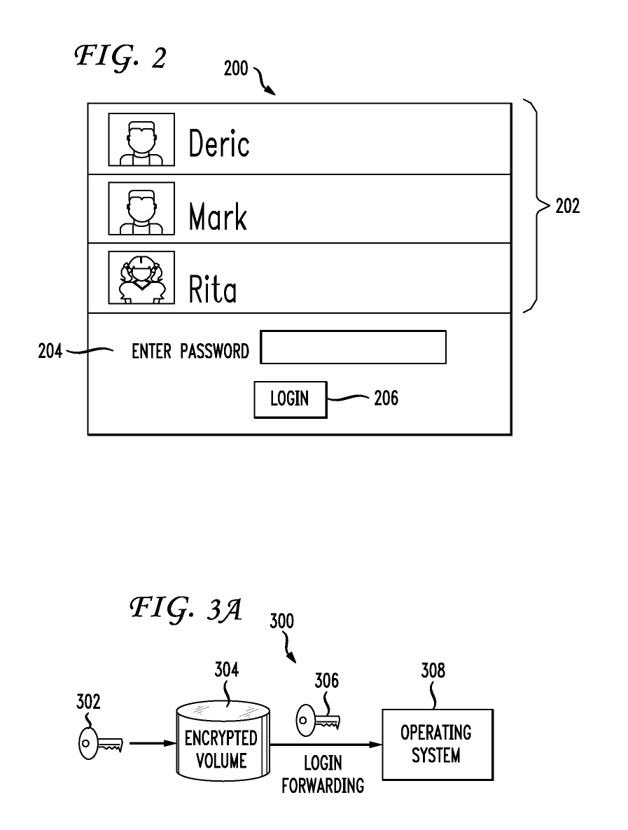

FIG. 2 illustrates an example boot-time login prompt 200, including a list of users 202 registered with the operating system and able to decrypt the encrypted volume, a password entry field 204, and a login 206 or submit button. The password entry field can be replaced with other suitable authentication input approaches, such as a PIN, biometric authentication (fingerprints, voiceprints, retina scan, facial recognition, and so forth), or pattern-based authentication. Typical prior art boot-time prompts for entering full-disk encryption credentials are text-based or a very minimal interface that bears no resemblance at all to a modern consumer operating system. In one embodiment, the example boot-time login prompt 200 appears to a user to be integrated with the operating system and not part of pre-operating system stage. While the actual boot-time login prompt 200 is not part of the operating system (and indeed cannot be because the operating system is stored on the encrypted storage volume which is not accessible at the point in time when the boot-time login prompt is loaded), image-based and other “tricks” can be employed to create a consistent user interface and appearance with the operating system.

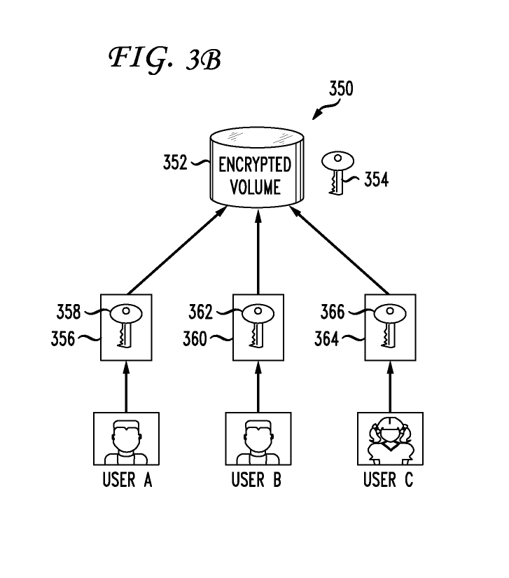

FIG. 3A illustrates an example flow 300 of login credentials. When the user enters the credentials in the boot-time login prompt 200 of FIG. 2, the system derives a disk encryption key 302 from the credentials and uses the disk encryption key 302 to decrypt the encrypted volume 304 storing the operating system 308. Once the system has the key to the encrypted volume 304, the encrypted volume is decryptable or unlocked for access. The system can read and begin loading the operating system 308, decrypting each block of the volume as it is read. The system derives operating system login information and uses login forwarding 306 to authenticate and log in to the operating system 308 based on the operating system login information without any additional input from the user. In this way, the user provides a single set of credentials at boot time (such as a user name and password) to both decrypt the encrypted storage device and log in to the operating system. In one aspect, a volume key decrypts the whole disk and the volume key can be encrypted with multiple users' passwords so that more than one user can log in through the unified boot-time login prompt.

FIG. 3B illustrates an example 350 of multiple user logins for an encrypted device 352. The encrypted device 352, or volume, is encrypted using a disk encryption key 354. Then, for each user account (for example, User A, User B, and User C), the system wraps or encrypts a copy 358, 362, 366 of the disk encryption key 354 with the respective user's login credentials 356, 360, 364. In this way, User A, User B, and User C can each decrypt the disk and log in to their own account, without having any knowledge of any of the other users' credentials. For example, when User A enters her credentials 356, the system can extract the corresponding copy 358 of the disk encryption key 354 to access the encrypted volume 352. Despite the fact that each user can decrypt the disk, no user has access to the account or data of any of the other users. The system can aggressively harvest username and password combinations by monitoring user accounts, profiles, and/or login/user-switching events of the operating system. When the system detects a new user, the system can extract all or part of the new user's credentials, and create new or synchronize existing user data in the operating system and/or in unencrypted boot storage to enable the new user to log in via the unified boot-time login prompt. Further, the system can synchronize data beyond just the credentials for use in the unified boot-time login prompt, such as a user login picture, short name, full name, initial boot preferences, permissions, user metadata, and so forth.

The unified boot-time login prompt can classify users into different types and take different actions upon decrypting the storage volume or device based on the user type. Some example user classifications include basic operating system user, operating system administrator, password recovery user, master password user, BIOS or EFI administrator, and so forth. When the user logs in as the password recovery user, the system can boot straight to a password reset window instead of a user login session. When the user logs in as a BIOS or EFI administrator, the system can boot straight to the BIOS or EFI management menu instead of the operating system. If the user logs in as the operating system administrator, the system can boot to a temporary menu displayed for a short time providing access to diagnostics and/or other administrator options.

The unified boot-time login prompt can introduce a delay upon a failed login attempt in order to slow down brute force attacks. In one aspect, the unified boot-time login prompt can provide minimal or rudimentary network access for a number of purposes, such as communicating with an authentication server, restoring from a network-based backup, sending an alert to a server with a time-stamp or a location-stamp (such as if the computing device is stolen).

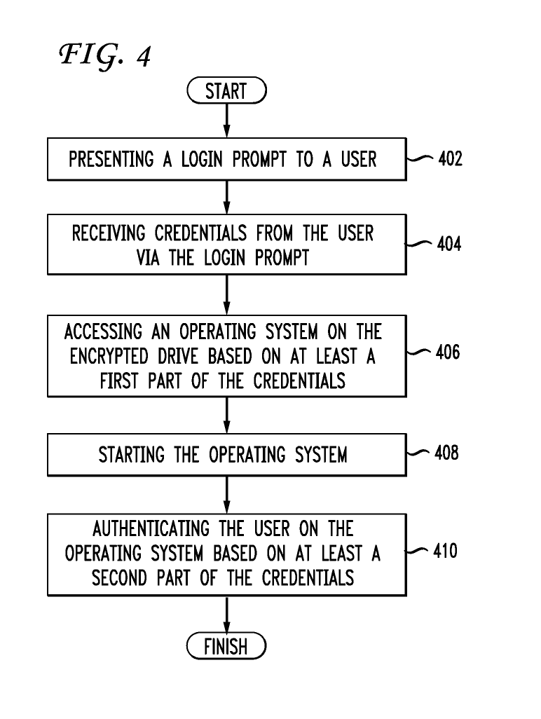

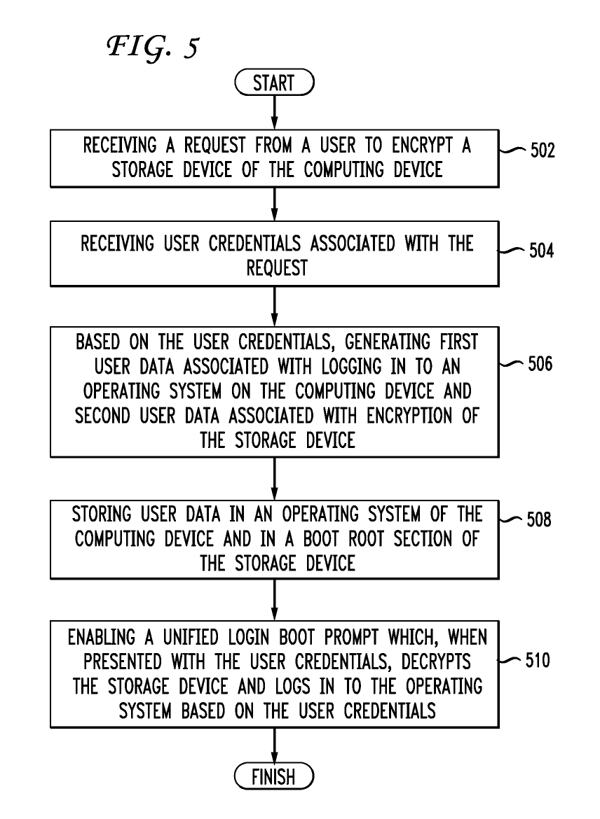

Having disclosed some basic system components and authentication concepts, the disclosure now turns to the exemplary method embodiments shown in FIGS. 4 and 5 for a single-login boot and for authenticating a user logging in to an operating system stored in encrypted storage. For the sake of clarity, the methods are discussed in terms of an exemplary system such as is shown in FIG. 1 configured to practice the methods.

FIG. 4 illustrates a first exemplary method embodiment for a single-login boot. The system 100 presents a login prompt to a user (402) and receives credentials from the user via the login prompt (404). The credentials can include a username, a password, biometric authentication data, a personal identification number, a user login picture, a short name, a full name, and/or a title. The credentials can be associated with a volume key, a username, and a password, and the credentials for the encrypted drive and the operating system can be synchronized. The system 100 accesses the operating system on the encrypted drive based on at least a first part of the credentials (406) and starts the operating system (408). Then the system authenticates the user on the operating system based on at least a second part of the credentials (410). The system can store the credentials, such as a username and password, in memory while the operating system starts, provide the credentials to the operating system once it has started, and remove the credentials from the memory once login is complete. As an added security measure, the system can deny access and disable the login prompt temporarily if the user enters invalid credentials. The credentials can be used for other purposes as well, such as decrypting other non-operating system storage, triggering certain actions on the computing device, or sending a local and/or network-based alert. In order to provide a more pleasing and unified user experience, the login prompt can graphically simulate a full login prompt of the operating system and/or user interactions with the operating system (such as mouse cursors, menu components, user interface widgets, hardware controls, fonts, and so forth), even though the login prompt occurs before the operating system is available.

To that effect, the login prompt can include graphical elements in a same style as the operating system, simulating or emulating operating system-specific widgets, color schemes, and so forth. The login prompt can display a user login picture, a short name, a full name, a biometric authentication widget, a password hint, a list of authorized users, computer name, operating system version, boot options, support options, and/or other login options.

FIG. 5 illustrates a second exemplary method embodiment for enrolling a user in a single-login boot and generating credentials for a computing device. The system 100 receives a request from a user to encrypt a storage device of the computing device (502). The user can make this request from within the operating system. The operating system, the boot process, and the disk encryption can be tightly integrated in order to facilitate smooth handling of the request. In one aspect, the storage device is already encrypted, and the request is to link the existing disk encryption with the user's operating system credentials. The system 100 receives user credentials associated with the request (504). The operating system can prompt the user to enter the user credentials or can retrieve the user credentials from the user's profile.

Based on the user credentials, the system 100 generates first user data associated with logging in to an operating system on the computing device and second user data associated with encryption of the storage device (506). The system 100 stores user data in an operating system of the computing device and in an unencrypted boot section of the storage device (508) and enables a unified login prompt which, when presented with the user credentials, decrypts the storage device and logs in to the operating system based on the user credentials (510). In this way, the user is able to enter only one set of credentials that are operative to both decrypt or otherwise provide access to an encrypted storage device and log in to an operating system stored on the encrypted storage device.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be applied to a desktop or portable computing device. Those skilled in the art will readily recognize various modifications and changes that may be made to the principles described herein without following the example embodiments and applications illustrated and described herein, and without departing from the spirit and scope of the disclosure.

We claim:

1. A method of authenticating a user logging in to an operating system stored on an encrypted drive, the method comprising:
presenting a login prompt to a user;
receiving credentials from the user via the login prompt;
accessing the operating system on the encrypted drive based on at least a first part of the credentials;
starting the operating system; and
authenticating the user on the operating system based on at least a second part of the credentials.

2. The method of claim 1, wherein the credentials are associated with a volume key, a username, and a password.

3. The method of claim 2, wherein the volume key, username, and password are synchronized.

4. The method of claim 2, further comprising:
storing the username and the password in memory while the operating system starts;
providing the username and the password to the operating system once the operating system has started; and
removing the username and password from the memory.

5. The method of claim 1, further comprising:
generating partially hashed credentials based on the credentials; and
providing the partially hashed credentials to the operating system once the operating system has started.

6. The method of claim 1, wherein the login prompt simulates a full login prompt of the operating system.

7. The method of claim 1, wherein the login prompt displays at least one of a short name, a full name, a biometric authentication widget, a password hint, a list of authorized users, computer name, operating system version, boot options, support options, and other options.

8. The method of claim 1, wherein the credentials comprise at least one of a username, a password, biometric authentication data, a personal identification number, a short name, a full name, and a title.

9. The method of claim 1, wherein the first part of the credentials and the second part of the credentials share at least some data.

10. A method of generating credentials for a computing device, the method comprising:
receiving a request from a user to encrypt a storage device of the computing device;
receiving user credentials associated with the request;
based on the user credentials, generating first user data associated with logging in to an operating system on the computing device and second user data associated with encryption of the storage device;
storing user data in an operating system of the computing device and in an unencrypted boot section of the storage device; and
enabling a unified login boot prompt which, when presented with the user credentials, decrypts the storage device and logs in to the operating system based on the user credentials.

11. The method of claim 10, wherein the user credentials are associated with a volume key, a username, and a password.

12. The method of claim 11, wherein the volume key, username, and password are synchronized for the operating system and the encryption of the storage device.

13. The method of claim 11, further comprising:
storing the username and the password in memory while the operating system starts;
providing the username and the password to the operating system once the operating system has started; and
removing the username and password from the memory.

14. The method of claim 10, further comprising:
generating partially hashed credentials based on the credentials; and
providing the partially hashed credentials to the operating system once the operating system has started.

15. A system for synchronizing an operating system login with a decryption prompt, the system comprising:
a processor;
an encrypted storage device storing an operating system;
a first module configured to control the processor to identify first user credentials associated with the operating system and second user credentials associated with decrypting the encrypted storage device; and
a second module configured to control the processor to update a unified boot-time login prompt based on the first user credentials and the second user credentials, wherein the unified boot-time login prompt is used for decrypting the encrypted storage device and authenticating a user based on a single set of user credentials.

16. The system of claim 15, wherein the unified boot-time login prompt simulates a full login prompt of the operating system.

17. The system of claim 15, wherein the unified boot-time login prompt displays at least one of a short name, a full name, a biometric authentication widget, a password hint, a list of authorized users, computer name, operating system version, boot options, support options, and other login options.

18. The system of claim 15, wherein the single set of user credentials comprises at least one of a username, a password, biometric authentication data, a personal identification number, a short name, a full name, and a title.

19. The system of claim 15, wherein the first user credentials and the second user credentials share at least some data.

20. A non-transitory computer-readable storage medium storing instructions which, when executed by a computing device, cause the computing device to authenticate a user logging in to an operating system stored on an encrypted drive, the instructions comprising:
presenting a login prompt to a user;
receiving credentials from the user via the login prompt;
accessing the operating system on the encrypted drive based on at least a first part of the credentials;
starting the operating system; and
authenticating the user on the operating system based on at least a second part of the credentials.

21. The non-transitory computer-readable storage medium of claim 20, wherein the login prompt simulates a full login prompt of the operating system.

22. The non-transitory computer-readable storage medium of claim 20, wherein the login prompt displays at least one of a short name, a full name, a biometric authentication widget, a password hint, a list of authorized users, computer name, operating system version, boot options, support options, and other options.

23. The non-transitory computer-readable storage medium of claim 20, wherein the credentials comprise at least one of a username, a password, biometric authentication data, a personal identification number, a short name, a full name, and a title.

24. The non-transitory computer-readable storage medium of claim 20, wherein the first part of the credentials and the second part of the credentials share at least some data.
